(19) United States
(12) Patent Application Publication
(10) Pub. No.: US 2026/0004152 A1
(43) Pub. Date: Jan. 1, 2026

(54) SYSTEM AND METHOD FOR PROVIDING TECHNICAL SUPPORT ASSISTANCE TO A USER

(71) Applicant: Honeywell International Inc., Charlotte, NC (US)

(72) Inventors: Manoj Kumar, Suwanee, GA (US); Jundai Zhang, Alpharetta, GA (US); Hakyung Kim, Charlotte, NC (US); Tabbasum Fatima, CONCORD, NC (US); Kasiraju Gopikrishnama Raju, Bangalore (IN)

(21) Appl. No.: 18/754,205

(22) Filed: Jun. 26, 2024

(51) Int. Cl. G06N 5/01

(52) U.S. Cl. CPC G06N 5/01

(57) ABSTRACT

A method for providing technical support assistance to a user is disclosed. The method comprises receiving at least one input query from a user; generating an optimized search query based at least on the at least one input query, one or more instructions, and historical data, using an artificial intelligence (AI) model; creating at least one vector representation search query based on the optimized search query, using the AI model; determining a plurality of similar vectors corresponding to the at least one vector representation search query from a plurality of vectors; filtering vectors from the plurality of similar vectors based on a predefined tunable threshold, using the AI model; generating at least one synthesized AI response for the user based on the vectors filtered using the AI model; displaying the at least one synthesized AI response and one or more feedback parameters to the user.

### TECHNOLOGICAL FIELD

The present disclosure relates to a technical support assistance, and more particularly relates to a system and a method for providing technical support assistance to a user using artificial intelligence (AI) technique.

### BACKGROUND

Customers encounter issues with products and seek assistance from domain experts, particularly engineers. Typically, the customers have raised queries related to troubleshooting product issues or seeking general knowledge enhancement about the products customers use. However, addressing the queries effectively has been challenging due to several factors. Firstly, sheer volume and complexity of technical publications and knowledge articles make addressing the queries time-consuming and labor-intensive for engineers to manually search through the repositories to find relevant information. Given the vast amount of information available across various Strategic Business Groups (SBGs), Global Business Entities (GBEs), and product families, engineers often struggle to locate specific and pertinent details needed to address customer queries accurately and efficiently. Further, the process of searching through technical publications and knowledge articles requires a high level of domain knowledge expertise. Not only do engineers need to possess deep understanding and familiarity with the products and their functionalities, but the engineers also need to navigate through diverse sources of information to find relevant solutions or insights.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a simplified summary to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In one example embodiment, a method for providing technical support assistance to a user is disclosed. The method comprises receiving, via at least one processor, at least one input query from a user. The at least one input query corresponds to a textual input related to a technical support. The method further comprises generating, via the at least one processor, an optimized search query based at least on the received at least one input query, one or more instructions, and historical data, using an artificial intelligence (AI) model. The method further comprises creating, via the at least one processor, at least one vector representation search query based at least on the optimized search query generated, using the AI model. The at least one vector representation search query corresponds to a vector representation of the at least one optimized search query. The method further comprises determining, via the at least one processor, a plurality of similar vectors corresponding to the at least one vector representation search query from a plurality of vectors stored in a vector database. The vector database comprises vector representation of a plurality of documents. Further, the method comprises filtering, via the at least one processor, one or more vectors from the plurality of similar vectors determined, based at least on a predefined tunable threshold, using the AI model. Further, the method comprises generating, via the at least one processor, at least one synthesized AI response for the user based at least on the one or more vectors filtered using the AI model. Thereafter, the method comprises displaying, via the at least one processor, the at least one synthesized AI response generated and one or more feedback parameters to the user. The one or more feedback parameters are configured to receive feedback from the user on the at least one synthesized AI response.

In some embodiments, the one or more instructions correspond to instructions for retrieving intent from the at least one input query received from the user and the historical data corresponds to chat history of the user.

In some embodiments, the optimized search query corresponds to a query generated after filtering out common words and sentences from the at least one input query, for retrieving the intent from the at least one input query.

In some embodiments, the predefined tunable threshold corresponds to a maximum number of the one or more vectors filtered from the plurality of similar vectors.

In some embodiments, the at least one synthesized AI response comprises at least one of a textual response, pictorial response, video response, audio response, or multimodal response.

In some embodiments, the one or more feedback parameters comprises at least one of thumbs up/thumbs down option, a citation verification option, a session rating option, and a comment option.

In some embodiments, the method further comprises receiving, via the at least one processor, the feedback corresponding to the at least one synthesized AI response from the user based at least on the one or more feedback parameters displayed to the user. The method further comprises collating, via the at least one processor, the feedback received from the user on each of the at least one synthesized AI response to create a feedback database. Thereafter, the method comprises matching, via the at least one processor, the optimized search query with the feedback database. Upon successful matching, the at least one processor is configured to provide verified citations to the user.

In some embodiments, the method further comprises training, via the at least one processor, the AI model based at least on the feedback received from the user and the at least one optimized search query. In some embodiments, the method further comprises generating, via the at least one processor, a hypothetical answer in response to the at least one input query based at least on the trained AI model.

In some embodiments, the AI model comprises a language understanding model, a language embedding model, and a text generation model. The language understanding model is configured to generate the optimized search query, filter the one or more vectors, and generate the at least one synthesized AI response. The language embedding model is configured to create the at least one vector representation search query based at least on the generated optimized search query. The text generation model is configured to generate the hypothetical answer in response to the at least one input query.

In some embodiments, the plurality of documents comprises at least one of an article, a technical publication, a research paper, a white paper, a patent, or a blog.

In another example embodiment, a system for providing technical support assistance to a user is disclosed. The system comprises a memory and at least one processor communicatively coupled to the memory. The at least one processor is configured to receive at least one input query from a user. The at least one input query corresponds to a textual input related to a technical support. Further, the at least one processor is configured to generate an optimized search query based at least on the received at least one input query, one or more instructions, and historical data, using an artificial intelligence (AI) model. Further, the at least one processor is configured to create at least one vector representation search query based at least on the optimized search query generated, using the AI model. The at least one vector representation search query corresponds to a vector representation of the at least one optimized search query. Further, the at least one processor is configured to determine a plurality of similar vectors corresponding to the at least one vector representation search query from a plurality of vectors stored in a vector database. The vector database comprises vector representation of a plurality of documents. Further, the at least one processor is configured to filter one or more vectors from the plurality of similar vectors determined, based at least on a predefined tunable threshold, using the AI model. Further, the at least one processor is configured to generate at least one synthesized AI response for the user based at least on the one or more vectors filtered using the AI model. Thereafter, the at least one processor is configured to display the at least one synthesized AI response generated and one or more feedback parameters to the user. The one or more feedback parameters are configured to receive feedback from the user on the at least one synthesized AI response.

In another example embodiment, a non-transitory machine-readable information storage medium is disclosed. The non-transitory machine-readable information storage medium comprises one or more instructions which when executed by at least one processor cause the at least one processor to receive at least one input query from a user, wherein the at least one input query corresponds to a textual input related to a technical support; generate an optimized search query based at least on the received at least one input query, one or more instructions, and historical data, using an artificial intelligence (AI) model; create at least one vector representation search query based at least on the optimized search query generated, using the AI model, wherein the at least one vector representation search query corresponds to a vector representation of the at least one optimized search query; determine a plurality of similar vectors corresponding to the at least one vector representation search query from a plurality of vectors stored in a vector database, wherein the vector database comprises vector representation of a plurality of documents; filter one or more vectors from the plurality of similar vectors determined, based at least on a predefined tunable threshold, using the AI model; generate at least one synthesized AI response for the user based at least on the one or more vectors filtered using the AI model; and display the at least one synthesized AI response generated and one or more feedback parameters to the user, wherein the one or more feedback parameters are configured to receive feedback from the user on the at least one synthesized AI response.

The above summary is provided merely for purposes of summarizing some exemplary embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained within the following detailed description and its accompanying drawings.

### BRIEF DESCRIPTION OF THE DRA WINGS

Having thus described certain example embodiments of the present disclosure in general terms, reference will hereinafter be made to the accompanying drawings, which are not necessarily drawn to scale, and wherein:

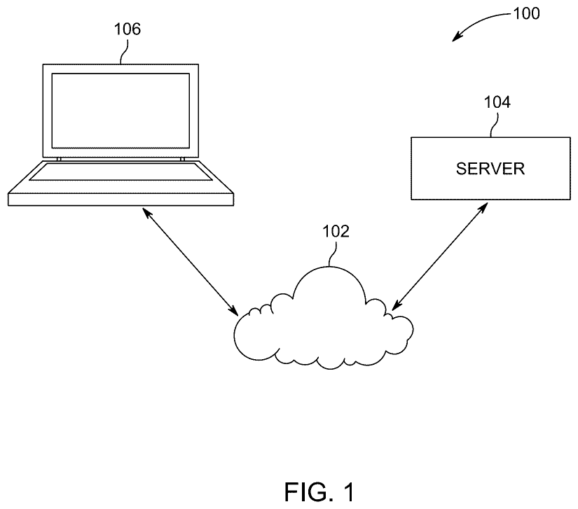

FIG. 1 illustrates a network diagram of a system for providing technical support assistance to a user in accordance with an example embodiment of the present disclosure;

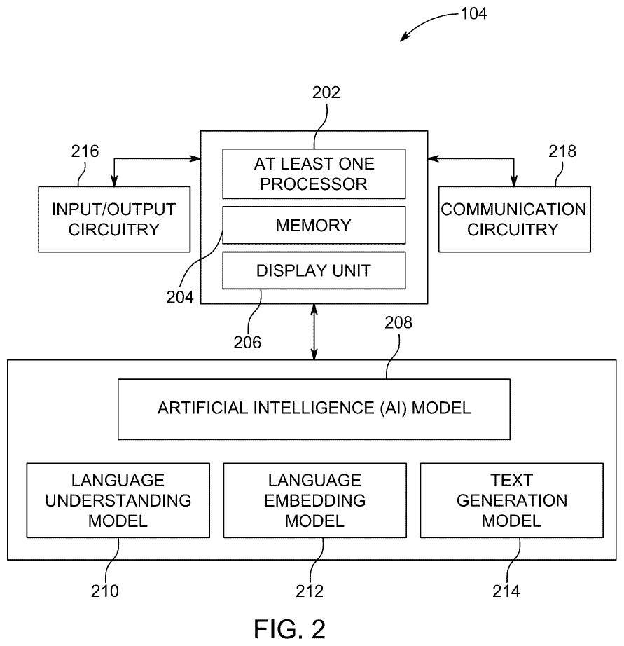

FIG. 2 illustrates a block diagram of a server in accordance with an example embodiment of the present disclosure;

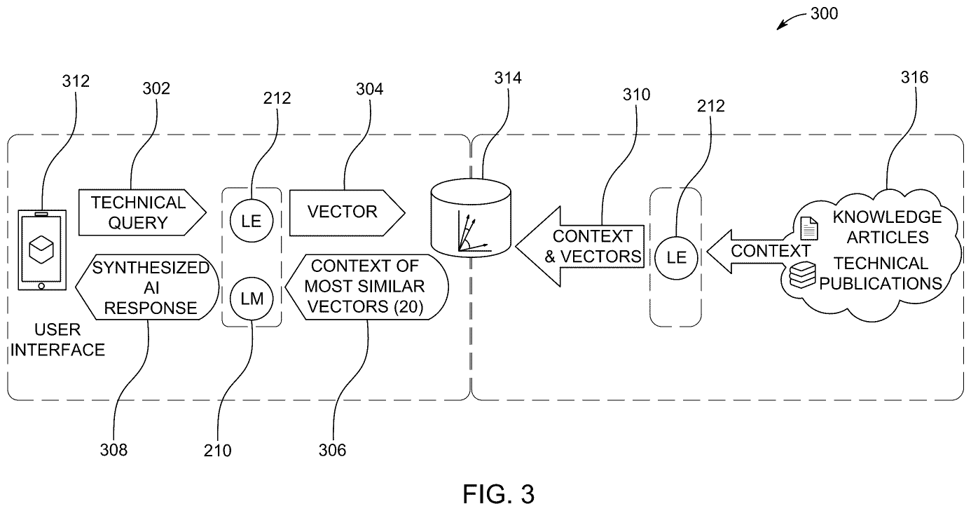

FIG. 3 illustrates a block diagram showing a method for providing technical support assistance to the user using an artificial intelligence (AI) model in accordance with an example embodiment of the present disclosure;

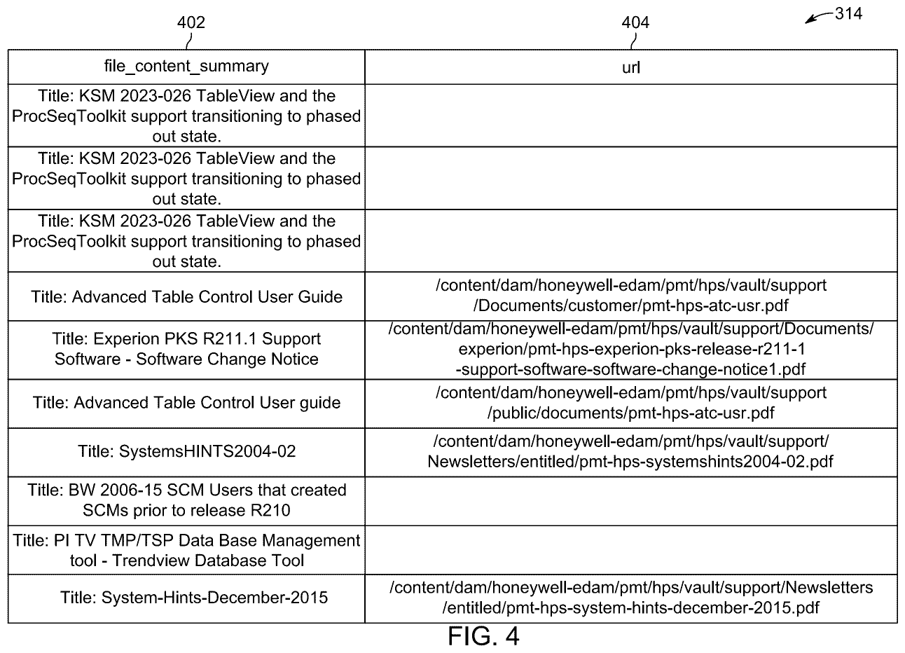

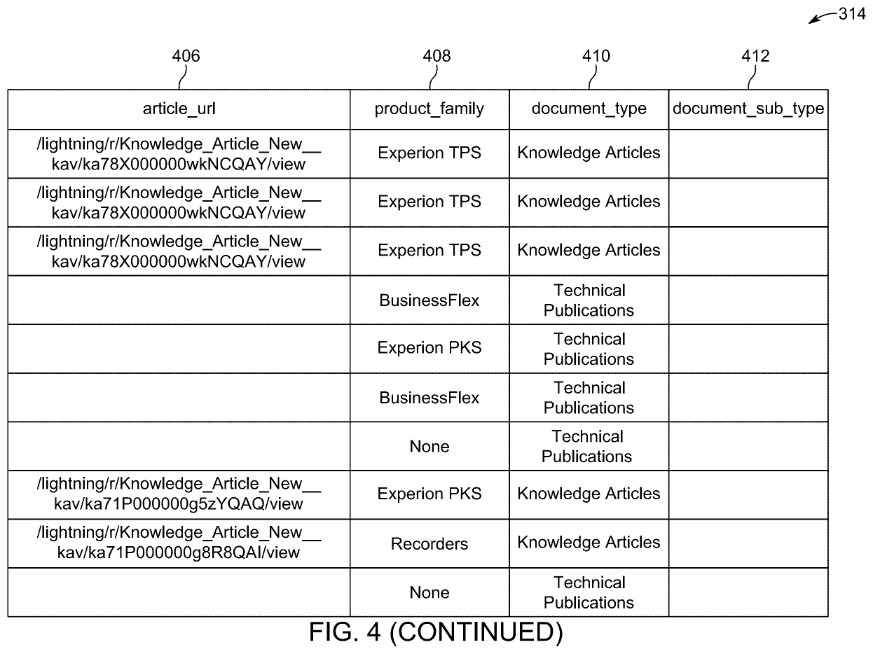

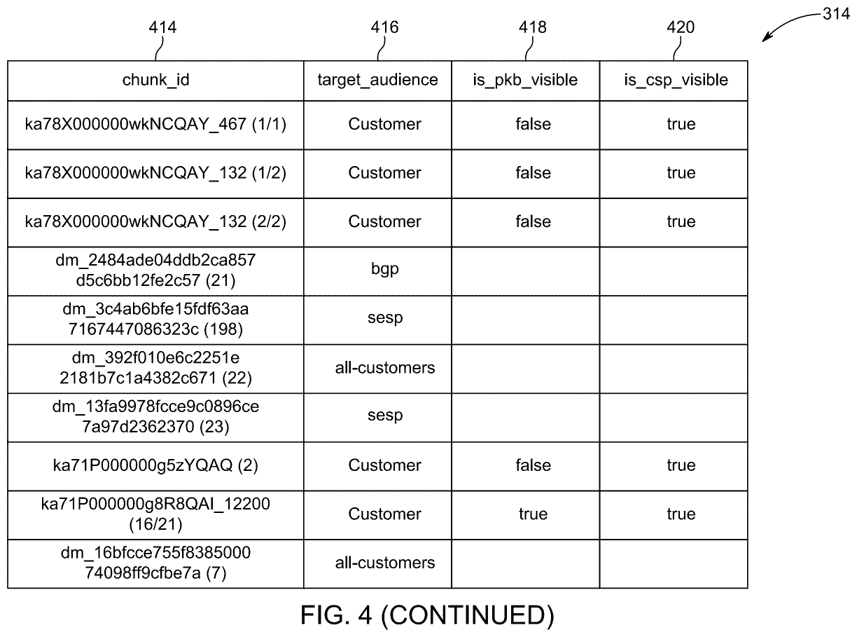

FIG. 4 illustrates a table of a vector database storing vector representation of a plurality of documents in accordance with an example embodiment of the present disclosure;

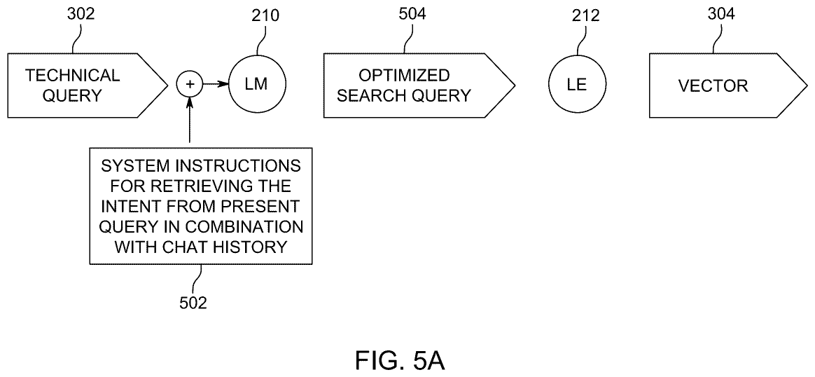

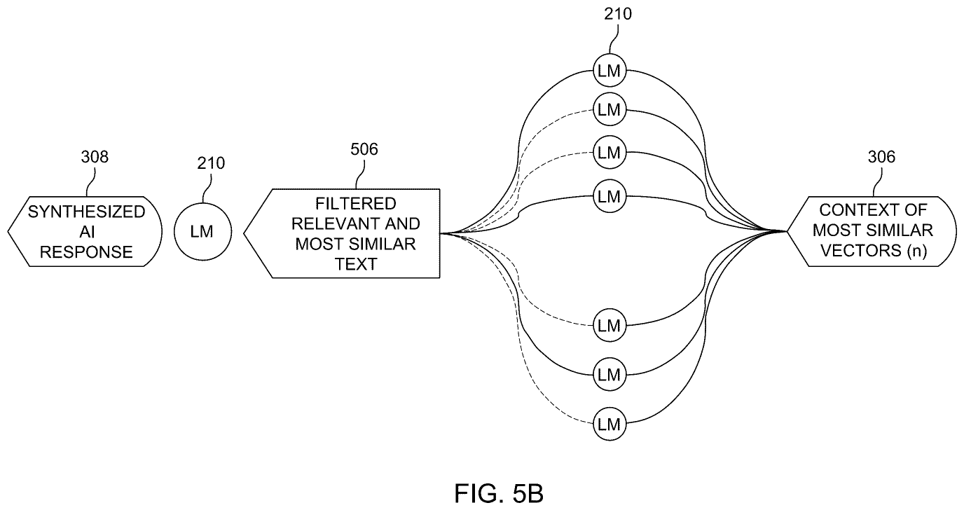

FIG. 5A illustrates a block diagram showing generation of an optimized search query using the AI model in accordance with an example embodiment of the present disclosure;

FIG. 5B illustrates a block diagram showing generation of at least one synthesized AI response for the user using the AI model in accordance with an example embodiment of the present disclosure;

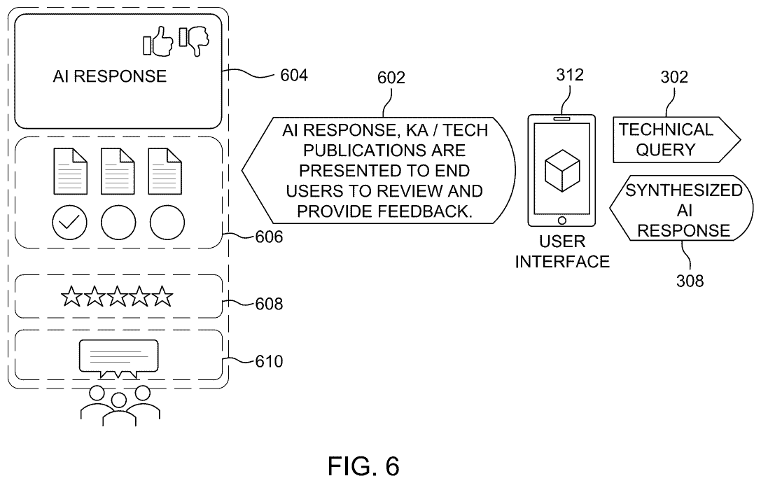

FIG. 6 illustrates one or more feedback parameters for receiving feedback from the user on the at least one synthesized AI response in accordance with an example embodiment of the present disclosure;

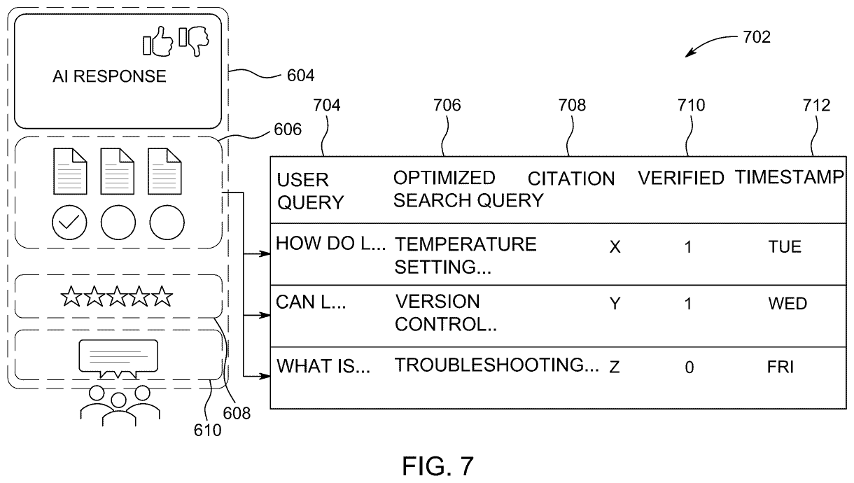

FIG. 7 illustrates a table of a citation database in accordance with an example embodiment of the present disclosure;

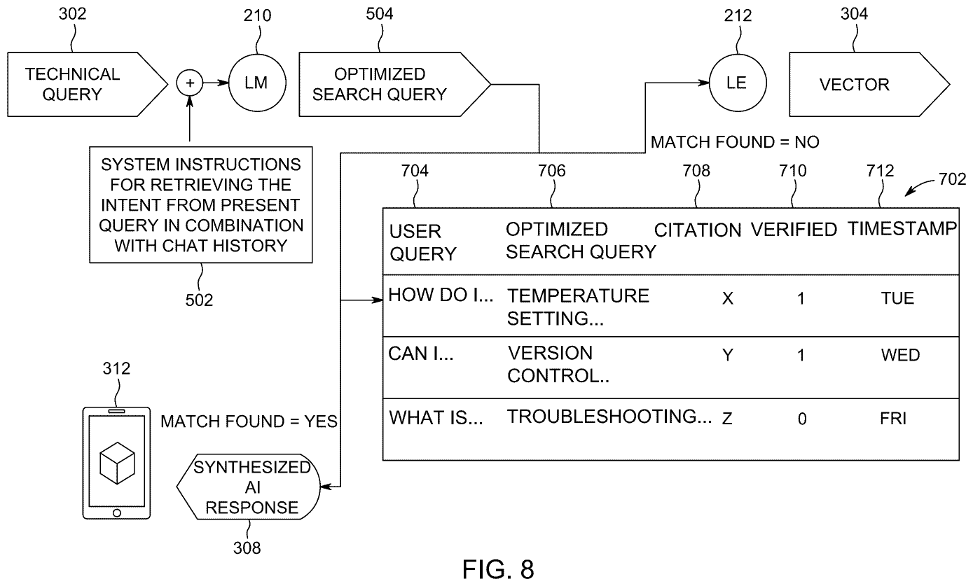

FIG. 8 illustrates a logical diagram to use matched verified citation from the citation database in accordance with an example embodiment of the present disclosure;

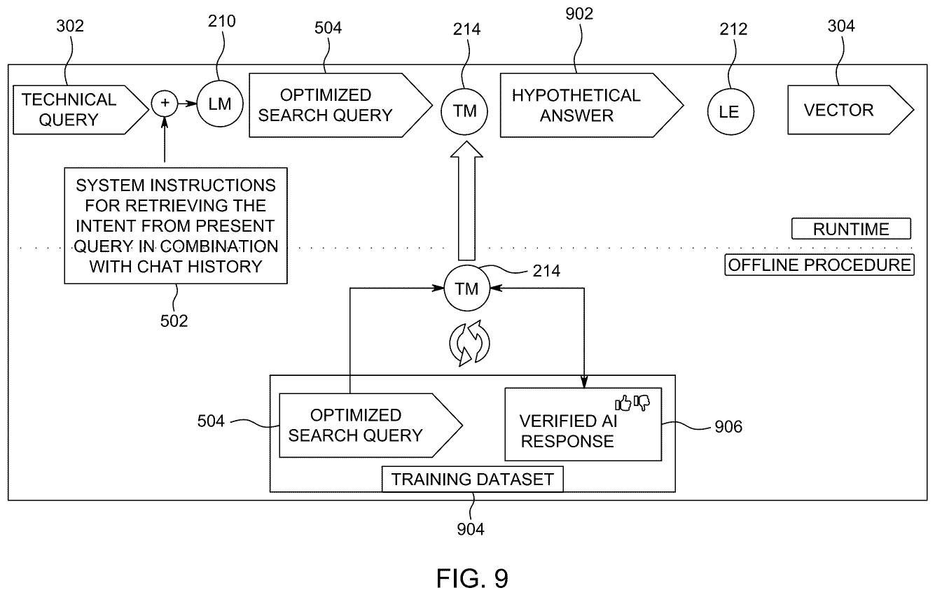

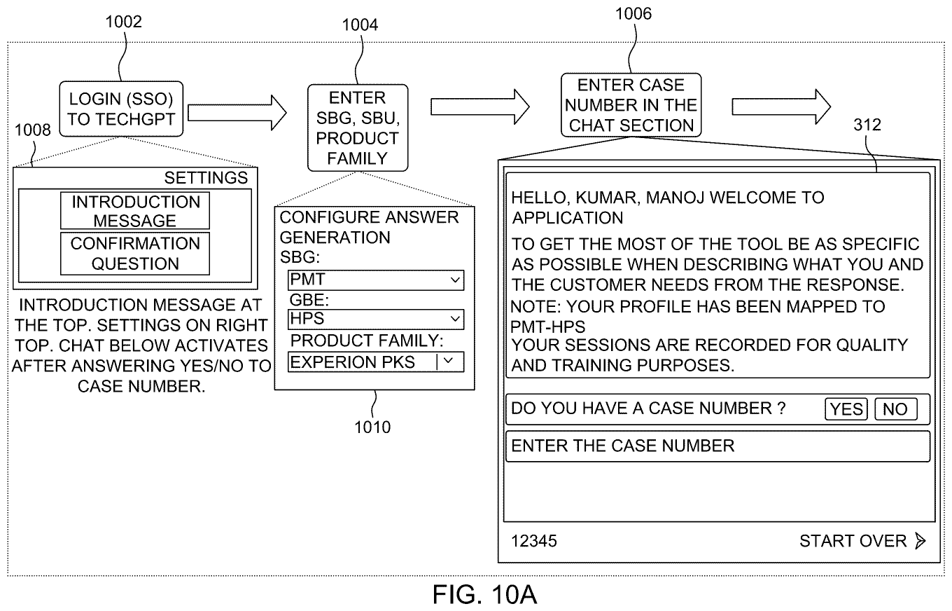

FIG. 9 illustrates a logical diagram showing a method for training the AI model based on the feedback received from the user and the at least one optimized search query in accordance with an example embodiment of the present disclosure;

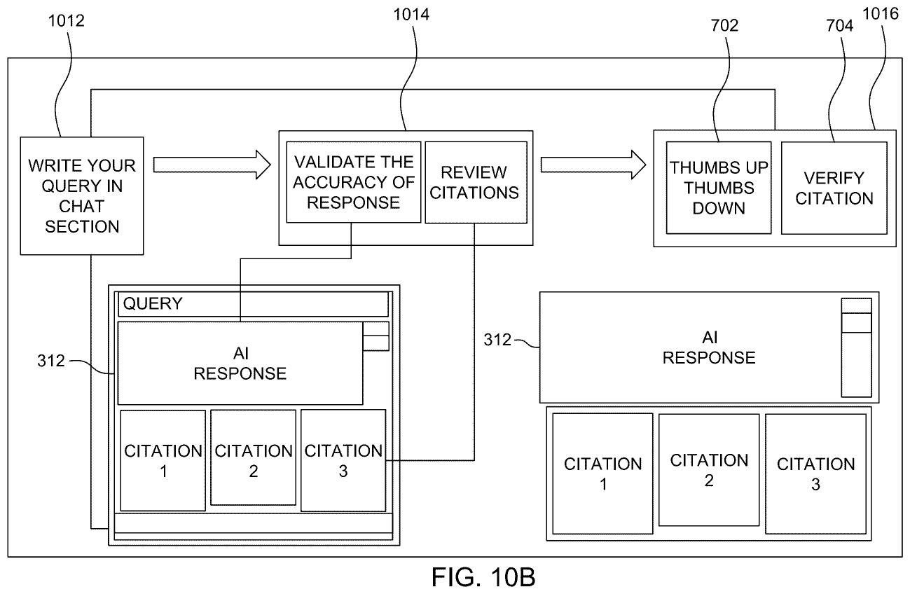

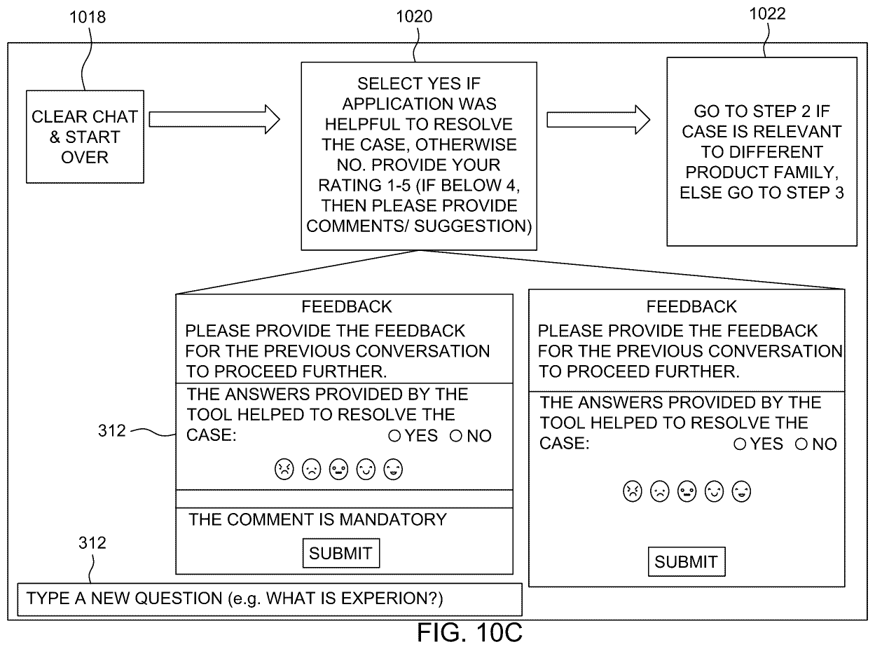

FIGS. 10A-10C illustrate a logical diagram showing a method for providing technical support assistance to the user using a user interface in accordance with an example embodiment of the present disclosure; and

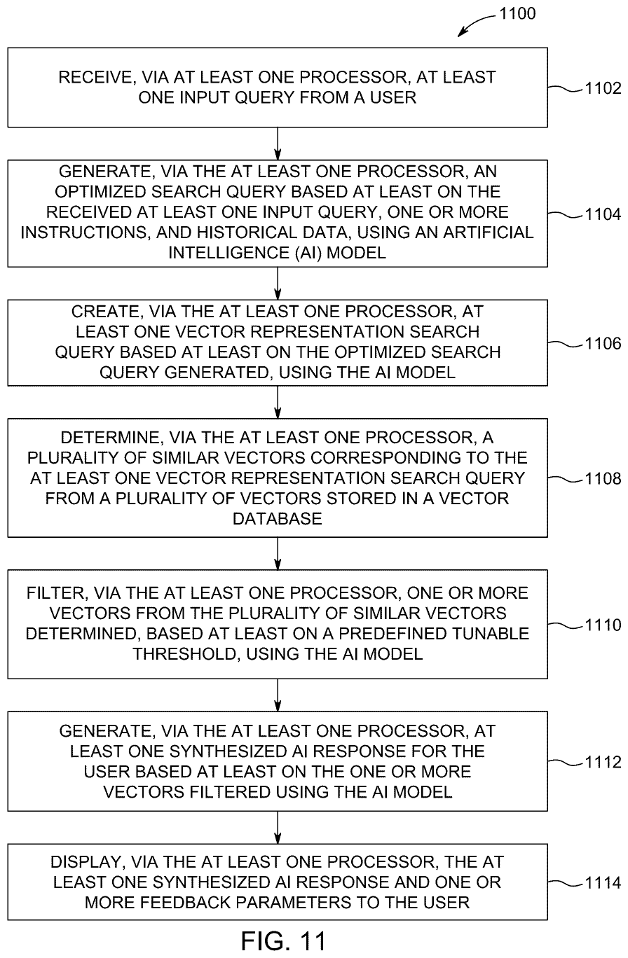

FIG. 11 illustrates a flowchart showing a method for providing the technical support assistance to the user in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the disclosure described herein such that embodiments may include fewer or more components than those shown in the figures while not departing from the scope of the disclosure. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of methods and systems for providing technical support assistance to a user. Embodiments may be configured to receive at least one input query from a user. The at least one input query corresponds to a textual input related to the technical support. Embodiments may be configured to generate an optimized search query based at least on the received at least one input query, one or more instructions, and historical data, using the AI model. Embodiments may be configured to create at least one vector representation search query based at least on the optimized search query generated, using the AI model. The at least one vector representation search query corresponds to a vector representation of the at least one optimized search query. Embodiments may be further configured to determine a plurality of similar vectors corresponding to the at least one vector representation search query from a plurality of vectors stored in a vector database. Embodiments may be further configured to filter one or more vectors from the plurality of similar vectors determined, based at least on a predefined tunable threshold, using the AI model. Further, embodiments may be configured to generate at least one synthesized AI response for the user based at least on the one or more vectors filtered using the AI model. Thereafter, embodiments may be configured to display the at least one synthesized AI response generated and one or more feedback parameters to the user. The one or more feedback parameters are configured to receive feedback from the user on the at least one synthesized AI response.

Embodiments may be configured to receive the feedback corresponding to the at least one synthesized AI response from the user based at least on the one or more feedback parameters displayed to the user. Embodiments may be configured to collate the feedback received from the user for each of the at least one synthesized AI response to create a feedback database. Embodiments may be configured to match the optimized search query with the feedback database. Upon successful matching, the at least one processor is configured to provide verified citations to the user. Embodiments may be further configured to train the AI model based at least on the feedback received from the user and the at least one optimized search query. Thereafter, embodiments may be configured to generate a hypothetical answer in response to the at least one input query based at least on the trained AI model.

FIG. 1 illustrates a network diagram of a system 100 for providing technical support assistance to a user, in accordance with an example embodiment of the present disclosure. The system 100 may comprise a network 102 communicatively coupled to a server 104 and a user device 106.

In some embodiments, the network 102 may be a communication network such as internet or a cloud network, that may be configured to allow computing devices and processing systems to communicate with each other through wired network, wireless network, or a combination of both. In some embodiments, the network 102 may refer to as a distributed infrastructure that is configured to exchange of data, information, and resources among interconnected computing devices and systems. The network 102 may be designed to facilitate communication and collaboration across various locations, devices, and platforms. Those skilled in the art will recognize that wired devices may include, but are not limited to, wired networks such as Wide Area Networks (WANs) or Local Area Networks (LANs), while wireless devices may include wireless communications established via Radio Frequency (RF) signals or infrared signals. Various devices in the system 100 may connect to the network 102 in accordance with various wired and wireless communication protocols such as Transmission Control Protocol and Internet Protocol (TCP/IP), User Datagram Protocol (UDP), and 2G, 3G, or 4G communication protocols.

Further, the system 100 may comprise the server 104. In some embodiments, the server 104 may be a computer or software module that is configured to provide centralized resources, data, or services to the user device 106 operated by the user. The server 104 may be configured to handle and manage one or more computational tasks and data processing within the system 100. In some embodiments, the server 104 may include storage systems, such as hard drives or storage arrays, to store and manage large volumes of data and information accessible to network users. In some embodiments, the server 104 may further provide centralized control and management capabilities, allowing network administrators to configure, monitor, and maintain network resources, security settings, and user access permissions from a single location.

In some embodiments, the server 104 may be configured to receive at least one input query from a user. The at least one input query may correspond to a textual input related to the technical support. The user may be an end user or a customer for accessing technical support. In one example, the at least one input query may correspond to “what is table view?”. Further, the at least one input query may correspond to “what are some alternatives?”. Further, the server 104 may be configured to generate an optimized search query based at least on the received at least one input query, one or more instructions, and historical data, using an artificial intelligence (AI) model. The optimized search query corresponds to a query generated after filtering out common words and sentences from the at least one input query, for retrieving the intent from the at least one input query. The AI model may correspond to a language understanding model. The language understanding model may be configured to understand the at least one input query. The language understanding model is further described in greater detail in conjunction with FIG. 2. In one example, the at least one optimized search query may correspond to “what are some alternative products for table view?”.

In some embodiments, the one or more instructions may correspond to instructions for retrieving intent from the at least one input query received from the user and the historical data corresponds to chat history of the user. In one example, the one or more instructions may correspond to “summarize what the user is trying to ask (DO NOT ANSWER THE QUERY) in up to 50 words, including relevant contextual information”. The one or more instructions may further correspond to “DO NOT OUTPUT the new user question as the answer to the current user query”. The one or more instructions may further correspond to “If the user query relates to the conversation history, generate a new context-rich user question as the search query”. The one or more instructions may further correspond to “when generating a new user question, prioritize chat history that is highly relevant to the user's current query”.

Further, the one or more instructions may correspond to “If the current user query is general and seeks an explanation from the most recent chat conversation, prioritize the latest chat history, or focus on previous assistant response”. Further, the one or more instructions may correspond to “If the current user query is entirely new and not related to chat history, output it as is without any modification”. The one or more instructions may further correspond to “Output a new user question that is accurate, relevant, and tailored to the user's needs. Make sure it's a question and not an answer”. The one or more instructions may further correspond to “Ensure that the new user question is not a follow-up question”. Further, the one or more instructions may correspond to “Ensure that the new user question is not an answer to the current user query”. Thereafter, the one or more instructions may correspond to “make sure that the new user question only contains the user question and not the summary”.

Further, the server 104 may be configured to create at least one vector representation search query based at least on the optimized search query generated, using the AI model. The AI model may correspond to a language embedding model. The language embedding model may be configured to create the at least one vector representation search query based at least on the generated optimized search query. The at least one vector may correspond to a numeric string. In some embodiments, a text may be converted into the at least one vector. In some embodiments, the text may be converted into a numeric format. The at least one vector may correspond to an array having size 1500, and may expand up to 3000. In some embodiments, each of the optimized search query may be converted into a unique at least one vector.

In some embodiments, the server 104 may determine a plurality of similar vectors corresponding to the at least one vector representation search query from a plurality of vectors stored in a vector database. The vector database comprises vector representation of a plurality of documents. In some embodiments, the server 104 may search the vector database to determine the plurality of similar vectors for the generated optimized search query. The number of the plurality of similar vectors may not be fixed. In one example, the plurality of similar vectors may correspond to 20 similar vectors corresponding to the at least one vector representation search query for the generated optimized search query. The vector database may store the vector representation of the plurality of documents. The plurality of documents may comprise at least one of an article, a technical publication, a research paper, a white paper, a patent, and a blog.

In some embodiments, the server 104 may be configured to filter one or more vectors from the plurality of similar vectors determined, based at least on a predefined tunable threshold, using the AI model. In some embodiments, the plurality of similar vectors may comprise the relevant one or more vectors corresponding to the optimized search query. In some embodiments, there may be a possibility that some of the plurality of similar vectors may not precisely match the user's intent or may contain irrelevant information. Further, the AI model may evaluate textual content of each of the plurality of similar vectors in comparison to the generated optimized search query. Further, the AI model may identify the one or more vectors that closely align with the user's at least one search query. Further, less relevant vectors or unrelated vectors may be filtered out. The filtering process may be conducted based at least on a predefined tunable threshold. The predefined tunable threshold may correspond to a maximum number of the one or more vectors filtered from the plurality of similar vectors.

Further, the server 104 may be configured to generate at least one synthesized AI response for the user based at least on the one or more vectors filtered using the AI model. The at least one synthesized AI response may comprise at least one of a textual response, pictorial response, video response, audio response, and multimodal response. The filtered one or more vectors from the plurality of similar vectors determined may represent the most relevant plurality of documents from the vector database, containing valuable information that addresses the at least one input query of the user. Further, the server 104 may display the at least one synthesized AI response generated and one or more feedback parameters to the user. The one or more feedback parameters may be configured to receive feedback from the user on the at least one synthesized AI response. The at least one synthesized AI response may comprise at least one of the textual response, pictorial response, video response, audio response, and multimodal response. The one or more feedback parameters may comprise at least one of thumbs up/thumbs down option, a citation verification option, a session rating option, and a comment option.

Further, the server 104 may receive the feedback corresponding to the at least one synthesized AI response from the user based at least on the one or more feedback parameters displayed to the user. Further, the server 104 may collate the received feedback from the user for each of the at least one synthesized AI response to create a feedback database. Further, the server 104 may match the optimized search query with the feedback database. Upon successful matching, the at least one processor may be configured to provide verified citations to the user. Further, the server 104 may update a citation database having the verified citations based at least on the collated feedback. Further, the server may be configured to train the AI model based at least on the feedback received from the user and the at least one optimized search query. Further, the server 104 may be configured to generate a hypothetical answer in response to the at least one input query based at least on the trained AI model. The AI model may correspond to a text generation model. In some embodiments, the server 104 may be configured to generate the optimized search query based at least on the received at least one input query, the one or more instructions, and the historic data using the Artificial Intelligence (AI)/Machine Learning (ML) techniques.

In one example embodiment, the one or more AI/ML techniques may correspond to natural language processing (NLP), clustering or unsupervised learning, reinforcement learning (RL) or any other AI/ML techniques known in the art. For instance, the NLP may enable the server 104 to generate the optimized search query based at least on the received at least one input query, the one or more instructions, and the historical data. Additionally, clustering or unsupervised learning may be employed to determine a plurality of similar vectors corresponding to the at least one vector representation search query from a plurality of vectors stored in a vector database. Furthermore, the RL technique may be utilized to dynamically optimize the at least one synthesized AI response to optimize the server 104 performance over time. The one or more AI/ML techniques may enable the server 104 to autonomously learn, adapt, and improve the technical information, to provide actionable insights and support proactive maintenance efforts.

In some embodiments, the server 104 may further be configured to accept the at least one input query from the user device 106. The user device 106 comprises a graphical user interface (GUI) that provides a user-friendly platform for the user to input the at least one input query and interact with the system 100. The GUI may be web-based, accessed through a browser, or through a dedicated software application installed on desktop computers, laptops, tablets, or smartphone. The user device 106 may be equipped by a user or other service professionals responsible for accessing the technical support and information. In some embodiments, the user device 106 may include personal computers such as desktop computers, laptop computers, tablets, smartphones, or mobile devices.

It will be apparent to one skilled in the art that above-mentioned components of the system 100 have been provided only for illustration purposes, without departing from the scope of the disclosure.

FIG. 2 illustrates a block diagram of the server 104, in accordance with an example embodiment of the present disclosure. The server 104 may comprise at least one processor 202, a memory 204, and a display unit 206. FIG. 2 is described in conjunction with FIG. 1.

In some embodiments, the at least one processor 202 may correspond to a controller for executing one or more operations within the server 104. In some embodiments, the server 104 may comprise the at least one processor 202 and the memory 204. The at least one processor 202 may be communicatively coupled to the memory 204. In some embodiments, the at least one processor 202 may be configured to receive at least one input query from the user via the user device 106. In some embodiments, the user device 106 may be laptop, smartphone, desktop etc. The at least one input query may correspond to a textual input related to technical support. The at least one input query may correspond to technical support regarding troubleshooting inquiries, conceptual understanding, product information requests, comparison queries, problem-solving assistance, operation, and working of a product. The user may be an end user or a customer for accessing technical support.

In one example, the at least one input query may correspond to “what is table view?”. Further, the at least one input query may correspond to “what are some alternatives?”. In another example, the at least one input query may correspond to “How do I fix error code XYZ on my device?”. In yet another example, the at least one input query may correspond to “Can you provide specifications for product ABC?”. In yet another example, the at least one input query may correspond to “What are the differences between model X and model Y?”. In yet another example, the at least one input query may correspond to “What are the minimum system requirements for software application Z?”. In yet another example, the at least one input query may correspond to “How do I set up wireless networking on my router?”. In yet another example, the at least one input query may correspond to “My computer won't boot up, what should I do?”. In yet another example, the at least one input query may correspond to “what are the steps to install a product?”. In some embodiments, the input query may be related to any technical assistance that might be required by the user for a device, application or any other product.

In some embodiments, the at least one processor 202 may be further configured to generate the optimized search query based at least on the received at least one input query along with the one or more instructions, and the historical data, using an AI model 208. The AI model 208 may correspond to a language understanding model 210. The language understanding model 210 may be configured to understand the at least one input query. In one example, the at least one optimized search query may correspond to “what are some alternative products for table view?” corresponding to the at least one input query “what is table view?”, and “what are some alternatives?”.

In some embodiments, the generation of the optimized search query may correspond to the generation of relevant and accurate query. The optimized search query may correspond to a query generated after filtering out common words and sentences from the at least one input query, for retrieving the intent of the user from the at least one input query. The at least one processor 202 may combine the at least one input query, chat history, and the one or more instructions, and send the combined at least one input query, chat history, and the one or more instructions to the AI model 208. The language understanding model 210 may gain an understanding of the user's context, preferences, and past interactions. Further, the language understanding model 210 may be configured to amalgamate the at least one input query with the chat history. The chat history may provide insights into the user's previous interactions and preferences. The chat history may allow the AI model 208 to tailor the at least one input query based at least on past conversations. Further, the one or more instructions may guide the AI model 208 in interpreting and processing the at least one input query effectively. Thereafter, the AI model 208 may generate the optimized search query.

In some embodiments, the language understanding model 210 may decipher intent embedded within the at least one input query. In some embodiments, upon receiving the at least one input query from the user, the language understanding model 210 may spring the at least one input query into action. The language understanding model 210 may analyze the at least one input query, and may break down the at least one input query to extract underlying meaning, nuances, and intent behind the user's at least one input query. Further, by employing advanced natural language processing (NLP) techniques, the language understanding model 210 may enable the server 104 to grasp the intricacies of the user language and accurately interpret the user queries, regardless of the complexity or ambiguity of the at least one input query.

Further, the at least one processor 202 may be configured to create the at least one vector representation search query based at least on the optimized search query generated, using the AI model 208. The AI model 208 may correspond to a language embedding model 212. The language embedding model 212 may be configured to create the at least one vector representation search query based at least on the generated optimized search query. The at least one vector may correspond to a numeric string. In some embodiments, a text from the optimized search query generated may be converted into the at least one vector. In some embodiments, the text may be converted into a numeric format. The at least one vector may correspond to an array having size 1500, and may expand upto 3000. In some embodiments, each of the optimized search query may be converted into a unique at least one vector (i.e., vector representation).

In some embodiments, the language embedding model 212 may convert the generated optimized search query, and the plurality of documents into the vector representation. Further, by employing techniques in natural language processing and machine learning, the language embedding model 212 may transform textual information into numerical vectors. The one or more vectors may encode semantic and contextual information about the textual information. In some embodiments, the language understanding model 210 may comprehend the nuances of the user language. Further, the language embedding model 212 may process the textual data and analyze the textual data effectively.

In some embodiments, the at least one processor 202 may determine a plurality of similar vectors corresponding to the at least one vector representation search query from the plurality of vectors stored in the vector database. The vector database may comprise vector representation of the plurality of documents. The plurality of documents may comprise at least one of the article, a technical publication, a research paper, a white paper, a patent, and a blog. In some embodiments, the at least one processor 202 may search the vector database to determine the plurality of similar vectors for the generated optimized search query. The number of the plurality of similar vectors may not be fixed. In one example, the plurality of similar vectors may correspond to 20 similar vectors corresponding to the at least one vector representation search query for the generated optimized search query. The vector database may store the vector representation of the plurality of documents.

In some embodiments, the at least one processor 202 may be configured to filter the one or more vectors from the plurality of similar vectors determined, based at least on the predefined tunable threshold, using the AI model 208. In some embodiments, the plurality of similar vectors may comprise the relevant one or more vectors corresponding to the optimized search query. In some embodiments, there may be a possibility that some of the plurality of similar vectors may not precisely match the user's intent or may contain irrelevant information. Further, the AI model 208 may evaluate textual content of each of the plurality of similar vectors in comparison to the generated optimized search query. Further, the AI model 208 may identify the one or more vectors that closely align with the user's at least one search query. Further, less relevant vectors or unrelated vectors may be filtered out. The filtering process may be conducted based at least on the predefined tunable threshold. The predefined tunable threshold may correspond to a maximum number of the one or more vectors filtered from the plurality of similar vectors.

Further, the at least one processor 202 may be configured to generate the at least one synthesized AI response for the user based at least on the one or more vectors filtered using the AI model 208. The at least one synthesized AI response may comprise at least one of a textual response, pictorial response, video response, audio response, and multimodal response. The filtered one or more vectors from the plurality of similar vectors determined may represent the most relevant plurality of documents from the vector database, containing valuable information that may address the at least one input query of the user.

Further, the server 104 may display the at least one synthesized AI response generated and one or more feedback parameters to the user. The one or more feedback parameters are configured to receive feedback from the user on the at least one synthesized AI response. The generated AI response may comprise at least one of the textual response, pictorial response, video response, audio response, and multimodal response. The one or more feedback parameters may comprise at least one of thumbs up/thumbs down option, a citation verification option, a session rating option, and a comment option. The displayed at least one synthesized AI response may correspond to a solution or an assistance corresponding to the at least one input query entered by the user, via the user device 106.

Further, the at least one processor 202 may receive the feedback corresponding to the at least one synthesized AI response from the user based at least on the one or more feedback parameters displayed to the user. In some embodiments, the users may provide feedback based at least on accuracy, relevance, and helpfulness of the displayed at least one synthesized AI response. The one or more feedback parameters may comprise at least one of the thumbs up/thumbs down option, the citation verification option, the session rating option, and the comment. The user may rate the displayed at least one synthesized AI response provided be the server 104. The user may further provide the comment. The comment may be related to suggestions for improvement. In some embodiments, the at least one processor 202 may analyze the received feedback, and may identify areas for optimization or refinement in the AI algorithms and knowledge retrieval processes. In some embodiments, the user device 106 may provide feedback mechanisms for the user to report issues encountered or suggest improvements. The feedback may empower the user to participate in improvement and refinement of the system 100. The user may suggest potential improvements to enhance user experience.

Further, the at least one processor 202 may collate the received feedback from the user for each of the at least one synthesized AI response to create the feedback database. Further, the at least one processor 202 may match the optimized search query with the feedback database. Upon successful matching, the at least one processor 202 may be configured to provide verified citations to the user. Further, the at least one processor 202 may update the citation database having the verified citations based at least on the collated feedback. Further, the at least one processor 202 may be configured to train the AI model 208 based at least on the feedback received from the user and the at least one optimized search query. Further, the at least one processor 202 may be configured to generate a hypothetical answer in response to the at least one input query based at least on the trained AI model 208. The AI model 208 may correspond to a text generation model 214. In some embodiments, the at least one processor 202 may be configured to generate the optimized search query based at least on the received at least one input query, the one or more instructions, and the historic data using the Artificial Intelligence (AI)/Machine Learning (ML) techniques.

In one example embodiment, the one or more AI/ML techniques may correspond to natural language processing (NLP), clustering or unsupervised learning, reinforcement learning (RL) or any other AI/ML techniques known in the art. For instance, the NLP may enable the server 104 to generate the optimized search query based at least on the received at least one input query, the one or more instructions, and the historical data. Additionally, clustering or unsupervised learning may be employed to determine a plurality of similar vectors corresponding to the at least one vector representation search query from a plurality of vectors stored in a vector database. Furthermore, the RL technique may be utilized to dynamically optimize the at least one synthesized AI response to optimize the server 104 performance over time. The one or more AI/ML techniques may enable the server 104 to autonomously learn, adapt, and improve the technical information, to provide actionable insights and support proactive maintenance efforts.

The at least one processor 202 may include suitable logic, circuitry, and/or interfaces that are operable to execute one or more instructions stored in the memory 204 to perform predetermined operations. In some embodiments, the at least one processor 202 may be configured to store the at least one input query, the generated optimized search query, the one or more vectors corresponding to the plurality of documents, and the feedback in the memory 204 communicatively coupled to the at least one processor 202. In one embodiment, the at least one processor 202 may be configured to decode and execute any instructions received from one or more other electronic devices or server(s). The at least one processor 202 may be configured to execute one or more computer-readable program instructions, such as program instructions to carry out any of the functions described in this description. Further, the processor may be implemented using the at least one processor 202 technologies known in the art. Examples of the at least one processor 202 include, but are not limited to, one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor).

In some embodiments, the memory 204 may be configured to store a set of instructions and data executed by the at least one processor 202. Further, the memory 204 may include the one or more instructions that are executable by the at least one processor 202 to perform specific operations. The memory 204 may be configured to store the at least one input query received from the user. The memory 204 may be configured to include the instructions to generate the optimized search query corresponding to the received at least one input query. The memory 204 may be configured to include the instructions to store the one or more vectors corresponding to the plurality of documents. The plurality of documents may comprise at least one of the article, the technical publication, the research paper, the white paper, the patent, and the blog. Further, the memory 204 may be configured to include the instructions to display the at least one synthesized AI response to the user.

The memory 204 may be configured to include the instructions to access the technical support corresponding to the at least one input query received from the user, via the user device 106. It is apparent to a person with ordinary skill in the art that the one or more instructions stored in the memory 204 enable the hardware of the system 100 to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

In some embodiments, the display unit 206 may display the generated at least one synthesized AI response. The display unit 206 may ensure that the generated at least one synthesized AI response may be shown in a plurality of formats that is most suitable for the user's preferences, enhancing the overall user experience. The plurality of formats may comprise a textual response format, a pictorial response format, a video response format, an audio response format, and a multimodal response format. The display unit 206 may further display the one or more feedback parameters to the user. The one or more feedback parameters may be configured to receive feedback from the user on the at least one synthesized AI response.

In some embodiments, the server 104 may further comprise an input/output circuitry 216. The input/output circuitry 216 may enable a user to communicate or interface with the system 100, via the user device 106. The user device 106 may include N number of user devices. In some embodiments, the input/output circuitry 216 may act as a medium to transmit input from the interface to and from the system 100. In some embodiments, the input/output circuitry 216 may refer to the hardware and software components that facilitate the exchange of information between the user device 106 and the system 100. In one example, the system 100 may include a graphical user interface (GUI) (not shown) as input circuitry to allow the users to input data. The input/output circuitry 216 may include various input devices such as keyboards, barcode scanners, GUI for the users to provide data and various output devices such as displays, printers for the one or more users to receive data. In another example, the input/output circuitry 216 may include various output circuitry such as a display. In one example, the input/output circuitry 216 may interface with the user device 106 to receive the at least one input query as input. The at least one processor 202 may process the at least one input query, generate the optimized search query corresponding to the at least one input query using the AI model 208, and may generate output signals to display the at least one synthesized AI response corresponding to the at least one input query provided by the user, via the user device 106. The input/output circuitry 216 may further display relevant information to the user on the user device 106.

In some embodiments, the server 104 may further comprise a communication circuitry 218. The communication circuitry 218 may allow the server 104 to exchange data or information with other systems or apparatuses. Further, the communication circuitry 218 may include network interfaces, protocols, and software modules responsible for sending and receiving data or information. In some embodiments, the communication circuitry 218 may include Ethernet ports, Wi-Fi adapters, or communication protocols like HTTP or MQTT for connecting with other systems. The communication circuitry 218 may further include components such as communication modules (e.g., Wi-Fi, Ethernet, cellular), transceivers, antennas, and protocols (e.g., TCP/IP, MQTT, SNMP) for exchanging data with other systems or network devices. The communication circuitry 218 may allow the system 100 to stay up-to-date. In some embodiments, the communication circuitry 218 may enable seamless communication between the user device 106, the language understanding model 210, and the language embedding model 212.

It will be apparent to one skilled in the art the above-mentioned components of the server 104 have been provided only for illustration purposes, without departing from the scope of the disclosure.

FIG. 3 illustrates a block diagram 300 showing a method for providing technical support assistance to the user using an artificial intelligence (AI) model, in accordance with an example embodiment of the present disclosure. FIG. 4 illustrates a table of a vector database 314 storing vector representation of a plurality of documents, in accordance with an example embodiment of the present disclosure.

In some embodiments, accessing the technical support using the AI, may involve runtime procedure and offline procedure. In the runtime procedure, the user may provide the at least one input query to the system 100 using a user interface 312, at step 302. The at least one input query may comprise the technical query. Further, the server 104 may generate the optimized search query, and then create at least one vector representation search query based at least on the optimized search query generated, using the language embedding model 212, at step 304. The optimized search query may be generated based at least on the at least one input query, the one or more instructions, and the historical data. The detailed description of the optimized search query will be described later in conjunction with FIG. 5A. Further, the server 104 may determine a plurality of similar vectors corresponding to the at least one vector representation search query from a plurality of vectors stored in a vector database 314, at step 306. Further, the server 104 may filter the one or more vectors from the plurality of similar vectors determined. Further, the server 104 may generate the at least one synthesized AI response, and display the at least one synthesized AI response to the user, at step 308. The displayed at least one synthesized AI response may correspond to the textual response, the pictorial response, the video response, the audio response, and the multimodal response.

In some embodiments, in the offline procedure, the plurality of documents may be converted into the one or more vectors, using the AI model 208, at step 310. The AI model 208 may correspond to the language embedding model 212. The plurality of documents may comprise at least one of the article, the technical publication, the research paper, the white paper, the patent, and the blog as illustrated by 316. Further, the converted one or more vectors may be stored in the vector database 314. Further, the server 104 may determine the plurality of similar vectors from the vector database 314.

In some embodiments, the vector database 314 may serve as a repository to contain the at least one vector representation of the plurality of documents. In one example, the vector database 314 may comprise at least one of a file content summary (as shown by 402) having title or description of the content corresponding to the vector, a uniform resource locator (URL) (as shown by 404) for the related vector, an article URL (as shown by 406) allowing access to full text or document of the related document to the user, a product family (as shown by 408) correspond to a group of related products that share common features, components, technologies, a document type (as shown by 410) may refer to a specific kind of data structure used to store and manage information, a document sub-type (as shown by 412), a chunk_ID (as shown by 414) may refer to an identifier associated with a specific chunk of data within the vector database 314, a target audience (as shown by 416) may refer to a specific group of users or customers that the documents are designed to serve, is_pkb_visible (as shown by 418), and is_csp_visible (as shown by 420). It may be noted that above-mentioned information in the vector database 314 has been provided only for illustration purposes. In another embodiment, the vector database 314 may contain additional information such as, but is not limited to, is_csp_visible_in app, is_visible_in_csp, an article number, a_sbg, and a_sbe, without departing from the scope of the disclosure.

FIG. 5A illustrates a block diagram 500 showing generation of an optimized search query using the AI model 208, in accordance with an example embodiment of the present disclosure. FIG. 5B illustrates a block diagram showing generation of at least one synthesized AI response for the user using the AI model 208, in accordance with an example embodiment of the present disclosure. FIGS. 5A-5B are described in conjunction with FIGS. 1-4.

In some embodiments, based at least on the technical query and system instructions for retrieving the intent from present query in combination with chat history (shown by 502), may be configured to generate an optimized search query as discussed earlier, at step 504. The optimized search query may be generated based at least on the received at least one input query, one or more instructions, and historical data, using the language understanding model 210. In some embodiments, the optimized search query may be defined as a well-structured and precise set of terms and operators used to retrieve the most relevant and accurate results from a search engine or database. The optimized search query may be configured to involve selecting the right keywords, using operators and modifiers effectively, and structuring the query to reduce irrelevant results and enhance the relevance of the retrieved information. In some embodiments, some key elements may be used by the language understanding model 210 for generating the optimized search query. The key elements may comprise keywords, operators, modifiers, filters, and advanced search features. The language understanding model 210 may use specific and relevant keywords that closely match the information the user is seeking. Further, void overly broad or generic terms that may return too many irrelevant results.

Further, the at least one vector representation search query may be created based at least on the optimized search query generated using the language embedding model 212, at step 304. The at least one vector representation search query may capture the essence and the semantic context of the user's at least one input query in a numerical form. In some embodiments, after creating the at least one vector representation search query of the at least one optimized search query, at step 304, the created at least one vector representation search query may be compared against all vectors corresponding to the plurality of documents stored in the vector database 314, at step 306. Further, by determining similarity between the created at least one vector representation search query and the at least one vector representation of the plurality of documents stored in the vector database 314, the one or more vectors may be filtered from the plurality of similar vectors, at step 506. The filtering of the one or more vectors may be based at least on the predefined tunable threshold, using the AI model 208. Further, the at least one synthesized AI response may be generated for the user based at least on the one or more vectors filtered using the language understanding model 210, at step 308. Thereafter, the at least one synthesized AI response and the one or more feedback parameters may be displayed to the user.

FIG. 6 illustrates one or more feedback parameters for receiving feedback from the user on the at least one synthesized AI response, in accordance with an example embodiment of the present disclosure. FIG. 7 illustrates a table of a citation database 702, in accordance with an example embodiment of the present disclosure. FIGS. 6-7 are described in conjunction with FIGS. 1-5B.

In some embodiments, the system 100 may comprise a feedback receiving mechanism. In some embodiments, the feedback receiving mechanism may encompass both quantitative and qualitative measures. The feedback receiving mechanism may ensure that the user opinions and preferences are captured at different stages of interaction of the user with the system 100. The feedback receiving mechanism may enable continuous improvement and refinement of the system 100 capabilities. In some embodiments, the server 104 may be configured to receive feedback from the user based at least on the displayed at least one synthesized AI response of the received at least one input query over the user interface 312, at step 602. In some embodiments, the feedback may be related to the knowledge article or technical publications. The feedback may be received via the one or more feedback parameters. The one or more feedback parameters may comprise the thumbs up/thumbs down option 604, the citation verification option 606, the session rating option 608, and the comment option 610. It may be noted that the user has to provide the feedback based at least on the displayed at least one synthesized AI response, using the one or more feedback parameters.

In some embodiments, the user may provide the rating for the thumbs up/thumbs down option 604 on the displayed at least one synthesized AI response. The thumbs up/thumbs down option 604 may be labeled as feedback 1. The thumbs up/thumbs down option 604 may allow the user to express immediate satisfaction or dissatisfaction on the displayed at least one synthesized AI response corresponding to the at least one input query. The thumbs up/thumbs down option 604 may be received for each of the at least one input query. In some embodiments, the displayed at least one synthesized AI response may be a summarized version of citations. The citations may be presented to the user for transparency. The citations may be verified by the user as relevant to the at least one input query. The citations may form the basis of the displayed at least one synthesized AI response. The citations may be offered to the user to verify the relevance of the displayed at least one synthesized AI response corresponding to the at least one input query. The citation verification option 606 may be labeled as feedback 2 and may be displayed to the user for each of the at least one input query. The citation verification option 606 may allow the user to confirm whether the citations aligned with the at least one input query. The citation verification option 606 may further provide valuable insights into the accuracy and appropriateness of the displayed at least one synthesized AI response.

In some embodiments, the user may have the flexibility to initiate a new session at any time. The new session may allow the user for seamless continuation or revision of the interactions with the system 100. In some embodiments, at the end of each session, two additional types of feedback parameters may be displayed to the user. The two additional types of feedback parameters may comprise the session rating option 608 and the comment option 610. The session rating option 608 may be labeled as feedback 3. The session rating option 608 may provide the user to rate on a scale of 1 to 5 to evaluate the overall satisfaction with the session experience. The session rating option 608 may help to gauge the effectiveness of the interaction and identifies areas for improvement for the system 100.

In one embodiment, if the session rating provided by the user may be 3, or below 3, then it may be mandatory for the user to provide the comment. In another embodiment, if the session rating provided by the user may be 4 or 5, then the user may leave the session without providing the comment. Further, the user may provide the comment and overall sentiments about the session in a free-form text format. In some embodiments, the comment option 610 may be labeled as feedback 4. The comment option 610 may allow the user to provide detailed feedback, share suggestions for enhancements, or express any concerns or frustrations the user may have encountered during the session.

In some embodiments, the server 104 may further comprise the citation database 702. The citation database 702 may contain verified citations sourced from the feedback received from the user. Each received citation may be associated with at least one specific input query against which the citation was verified, along with metadata. The metadata may comprise a number of users who verified the citations. Further, the citation database 702 may be updated as the user provides the citation verification feedback using the citation verification option 606. The citation database 702 may comprise one or more columns such as at least one user query (shown by 704), the optimized search query (shown by 706), the citation (shown by 708), a number of users who verified the citation (shown by 710), and a timestamp (shown by 712).

In one example embodiment, the user may provide a user query 704 as “how do I change temperature setting?”. Further, the optimized search query 706 may be “temperature settings change”. Further, the citation 708 may show a citation X that may be verified by one user as “1” in the number of users who verified the citation 710. Further, the column timestamp 712 may show “Tuesday”.

FIG. 8 illustrates a logical diagram to use matched verified citation from the citation database 702, in accordance with an example embodiment of the present disclosure. FIG. 8 is described in conjunction with FIGS. 1-7.

In some embodiments, when a new at least user input query may be provided by the user, at step 302. The server 104 may employ the language understanding model 210 to generate the optimized search query based at least on the received at least one input query. Further, the server 104 may match the generated at least one optimized search query against all search queries stored in the citation database 702.

In one embodiment, if a match is found, indicating similarity between the new at least one input query and the previously addressed at least one input query, the server 104 may proceed to retrieve the matching verified citations associated with the matched at least one input query. The server 104 may further display the retrieved matching verified citations to the user. The citation may serve as the trusted source of information relevant to the at least one input query provided by the user. The citation database 702 may grow as the user may provide the feedback. The citations verified by the user become increasingly reliable indicators of relevance and accuracy.

In another embodiment, if no match is found between the new at least one input query and the search queries stored in the citation database 702, then the server 104 may generate the at least one optimized search query, at step 306 as discussed earlier. Further, the server 104 may create the at least one vector representation search query based at least on the optimized search query generated, at step 304. Further, the server 104 may determine the plurality of similar vectors corresponding to the at least one vector representation search query from the plurality of vectors stored in the vector database 314. Further, the server 104 may generate the at least one synthesized AI response corresponding to the at least one input query, at step 308. Thereafter, the server 104 may display the at least one synthesized AI response to the user.

FIG. 9 illustrates a logical diagram showing a method for training the AI model 208 based on the feedback received from the user and the at least one optimized search query, in accordance with an example embodiment of the present disclosure.

In some embodiments, the at least one input query may be provided by the user, via the user device 106, at step 302. Further, the optimized search query may be generated based at least on the at least one input query, the one or more instructions, and the historical data, at step 504. Further, the generated optimized search query may be converted into the at least one vector representation search query, at step 304. The converted at least one vector representation search query may lead high similarity with the plurality of documents. In some embodiments, an enhancement may be introduced to further improve the relevance of the plurality of documents. The introduced enhancement may involve creation of a hypothetical answer based at least on the generated optimized search query, using the AI model 208, at step 902. The AI model 208 may correspond to the text generation model 214. Further, the hypothetical answer may be converted into the at least one vector representation search query, using the AI model 208, at step 304. The hypothetical answer may increase the similarity between the converted vectors and the relevant plurality of documents.

In some embodiments, the offline procedure may be developed to create the text generation model 214. The text generation model 214 may be trained using a training dataset 904. The training dataset 904 may comprise the verified AI response (shown by 906) corresponding to the at least one input query. The training dataset 904 may be collected from the feedback provided by the user, corresponding to the displayed at least one synthesized AI respond. The provided feedback may comprise the thumbs up/down option 604 corresponding to the displayed at least one synthesized AI response. The training dataset 904 may serve as foundation for training the text generation model 214. The training dataset 904 may enable the text generation model 214 to learn patterns and generate the hypothetical answer based at least on the received at least one input query.

In one example embodiment, the server 104 may receive the at least one input query “differences between Cat Max and Kata Max” from the user, via the user device 106. Further, the server 104 may generate the optimized search query “What are the differences between Cat Max and Kata Max?” based at least on the received at least one input query, the one or more instructions, and the historical data. Further, the server 104 may create the at least one vector representation search query based at least on the optimized search query generated, using the AI model 208. In some embodiments, the generated at least one synthesized AI response corresponding to the created at least one vector representation search query may correspond to “Cat Max and Kata Max are different in their design and usage. Cat Max is a product from UOP used for Platforming reactor internals. It has similar mechanical strength as the previously specified Optimizer TM and provides benefits in reducing the risk of scallop crushing damage due to reactor bed pressure.

The geometry of the Cat Max allows an increase in catalyst volume in existing reactors, providing process benefits in terms of yield performance and activity over the Optimizer. For new unit design, its benefit could reduce the reactor stack height and shorter transfer pipe length between the reactor and fired heater, resulting in a reduction in capital cost [000006844.ka]. On the other hand, Kata Max is a proprietary cation resin impregnated packing from Koch Glitch. Both fresh and spent Kata Max require special handling. Fresh Kata Max packing needs to be washed off free acidity and debris with de-ionized water before installation. It is critical to keep the packing wet throughout to prevent resin attrition due to drying. Spent Kata Max packing should still be treated as a chemical that requires safe disposal [000006422.ka].” Further, similarity score between the generated optimized search query and the generated at least one synthesized AI response may be 0.87.

In another embodiment, the server 104 may create the hypothetical answer based at least on the generated optimized search query, using the text generation model 214. The created hypothetical answer may correspond to “Cat Max and Kata Max are two different products with distinct features and applications. Cat Max is typically used in petrochemical reactor internals for enhancing the performance of catalytic processes, while Kata Max is a type of packing material used in chemical separation processes. The main differences lie in their material composition, intended use within industrial settings, and the specific benefits they provide in their respective applications”. Further, the server 104 may convert the created hypothetical answer into the at least one vector representation search query. Further, the generated at least one synthesized AI response corresponding to the converted at least one vector representation search query may comprise “Cat Max and Kata Max are different in their design and usage.

Cat Max is a product from UOP used for Platforming reactor internals. It has similar mechanical strength as the previously specified Optimizer TM and provides benefits in reducing the risk of scallop crushing damage due to reactor bed pressure. The geometry of the Cat Max allows an increase in catalyst volume in existing reactors, providing process benefits in terms of yield performance and activity over the Optimizer. For new unit design, its benefit could reduce the reactor stack height and shorter transfer pipe length between the reactor and fired heater, resulting in a reduction in capital cost [000006844.ka]. On the other hand, Kata Max is a proprietary cation resin impregnated packing from Koch Glitch. Both fresh and spent Kata Max require special handling. Fresh Kata Max packing needs to be washed off free acidity and debris with de-ionized water before installation. It is critical to keep the packing wet throughout to prevent resin attrition due to drying. Spent Kata Max packing should still be treated as a chemical that requires safe disposal [000006422.ka].” Further, the similarity score between the created hypothetical answer and the generated at least one synthesized AI response may be 0.94.

In some embodiments, the text generation model 214 may iteratively generate prompts based at least on the training dataset 904. The text generation model 214 may be used to create the hypothetical answer, at step 902. The generated prompts may extract responses that may be relevant and informative, aligning closely with the received at least one input query. In some embodiments, through continuous iteration, the text generation model 214 may produce increasingly accurate and effective prompts that improve the quality of the created hypothetical answer.

In some embodiments, updates to the text generation model 214 may be planned at regular intervals. The updates may be planned on a monthly basis to ensure the continued relevance. Further, deployment of a new model may depend upon availability of incremental feedback samples. Such incremental feedback samples may correspond to reaching a threshold of 100 new feedback samples.

FIGS. 10A-10C illustrate a logical diagram showing a method for providing technical support assistance to the user using a user interface, in accordance with an example embodiment of the present disclosure.

In some embodiments, the user may login (simple sign-on i.e., SSO) to a technical application, for example, TechGPT, at step 1002. The user may login to the technical application with credentials. The credentials may comprise a username and a password. Upon successful authentication, the user may gain access to a login window 1008. The login window 1008 may comprise introduction message for the user at the top of the login window 1008. The login window 1008 may further comprise settings option on right top of the login window 1008. Further, the login window 1008 may comprise a confirmation question.

Further, the user may go to the settings section. In some embodiments, within the settings section, the user may have the option to customize by entering one or more parameters, at step 1004. The one or more parameters may comprise Strategic Business Group (SBG), Global Business Entity (GBE), and product family as shown by 1010. The settings may tailor the information retrieval process to the user's specific domain or area of interest, ensuring that the at least one synthesized AI response may be relevant and aligned with the user's preferences and requirements.

Further, after configuring the settings, the user may navigate to the chat interface to initiate a conversation. Within the chat section, the user may have the option to enter the case number related to the at least one input query. The user may enter the case number in a chat section, at step 1006. The case number may streamline the communication process, enabling the system 100 to retrieve relevant information associated with the specified case number as shown on the user interface 312. In one example, the user may receive a message “Hello Kumar, Manoj Welcome to TechApp”. Further, the user interface 312 may display a question “Do you have a case number?” along with options of “YES” or “NO”. The user may select the option “YES” to enter the case number.

Further, once the case number may be entered, the user may begin the conversation by typing the at least one input query, at step 1012. In some embodiments, the advanced natural language processing (NLP) algorithms and machine learning models may interpret the at least one input query entered by the user. The advanced natural language processing (NLP) algorithms and the machine learning models may further analyze the intent and context of the at least one input query, and may retrieve the relevant information from the system's 100 vast repositories of the plurality of documents.

Further, the advanced natural language processing (NLP) may interpret the at least one input query, analyze the intent of the at least one query, and retrieve the relevant information from the system's vast repository of the plurality of documents. Further, the system 100 may generate the at least one synthesized AI response corresponding to the at least one input request. The system 100 may further display the generated at least one synthesized AI response.

In some embodiments, upon displaying the generated at least one synthesized AI response, the user may review the displayed at least one synthesized AI response to assess the accuracy and relevance of the displayed at least one synthesized AI response corresponding to the at least one input query. The user may examine the displayed at least one synthesized AI response provided by the system 100 to determine if the displayed at least one synthesized AI response may address the at least one input query provided by the user adequately. The user may validate the accuracy of the displayed at least one synthesized AI response. In some embodiments, the user may have the option to review citations associated with the displayed at least one synthesized AI response. The reviewed citations may further validate the accuracy of the displayed at least one synthesized AI response. The user may review citations and validate the accuracy of the displayed at least one synthesized AI response, at step 1014.

In some embodiments, after reviewing the displayed at least one synthesized AI response and the verified citations, the user may provide the feedback to the system 100, at step 1016. The received feedback from the user may comprise the thumbs up/thumbs down option 604, the citation verification option 606, the session rating option 608, and the comment option 610. The thumbs up/thumbs down option 604 and the citation verification option 606 may be received from the user after displaying every at least one synthesized AI response to the user. In some embodiments, the user may indicate the satisfaction with the displayed at least one synthesized AI response by selecting either the thumbs up or thumbs down. The user may also confirm the relevance of the citations provided. The feedback may enable the user to contribute to the refinement and improvement of the system's performance over time.

In some embodiments, after providing the feedback, the user may have the option to clear the chat and start a new conversation. The user may clear the chat and start the new conversation, at step 1018. The new conversation feature may allow the user to engage with the advanced natural language processing (NLP) corresponding to the at least one input query. In some embodiments, the user may initiate multiple conversations within the same session.

In some embodiments, after the conclusion of the session, the user may be prompted to rate the overall experience with the technical application, at step 1020. The rating may comprise on a scale of 1 to 5. The rating feedback may reflect the user's satisfaction with the session's effectiveness, usability, and responsiveness. If the rating is 3 or below, then it may be mandatory for the user to provide the comment. Further, if the rating is 4 or 5, then it may not be mandatory for the user to provide the comment. The user may provide comments or feedback on the session experience, allowing the user to express any suggestions or concerns for further improvement. Further, if the new at least one input query may belong to a different product family, then enter the case number in the chat section, at step 1006. Further, if the case may be relevant to different product family, user may be given the option as shown in step 1004 else go to step 1006, as shown in step 1022.

In some embodiments, the interaction process within the system's chat interface may involve entering the at least one input query, reviewing the displayed at least one synthesized AI response and the citations, providing the feedback, clearing the chat if needed, evaluating the session experience, and rating the session experience. Further, the system 100 may ensure that the user may receive accurate and relevant information. In some embodiments, the system 100 may utilize Raga framework. The raga framework may streamline the process of information retrieval and generation of the at least one synthesized AI response within the system 100. RAGA may stand for Retrieve, Augment, Generate, and Assess, encapsulating the key stages involved in the interaction between the user and the system 100.

In some embodiments, the retrieve stage may involve accessing the vast repositories of the plurality of documents. The plurality of documents may correspond to knowledge articles and technical publications from the specified strategic business groups, the global business entities, and the product families. The retrieve stage may leverage AI technology to efficiently search through the accessed repositories, retrieving relevant information based on the at least one input query provided by the user.

In some embodiments, in the augment stage, the server 104 may be configured to assimilate the retrieved relevant information determined from the retrieve stage. In some embodiments, following the augment stage, the generate phase comes into play. In the generate phase, the server 104 may utilize the assimilated relevant information from the previous stages to generate informative and relevant AI response. Further, utilizing the text generation model 214 and the AI algorithm, the server 104 may craft the at least one synthesized AI response that may address the at least one input query effectively. The at least one input query may further correspond to the troubleshooting technical issues, understanding complex concepts, or seeking product information.

In some embodiments, in the assess stage, the server 104 may evaluate the quality and relevance of the generated at least one synthesized AI response to ensure that the generated at least one synthesized AI response may meet the user's expectations. The assess stage may involve comparing the generated at least one synthesized AI response against the verified citation, analyzing the feedback received from the user, and refining the at least one synthesized AI response generation process iteratively to enhance accuracy and user satisfaction.

In some embodiments, the raga framework may provide a systematic and structured approach to information retrieval and response generation within the system 100. In some embodiments, by following the raga framework, the system 100 may effectively navigate the complexities of the at least one input query, harnessing the AI technology to deliver timely, accurate, and tailored AI response.

FIG. 11 illustrates a flowchart 1100 showing a method for providing the technical support assistance to the user, in accordance with an example embodiment of the present disclosure. FIG. 11 is described in conjunction with FIGS. 1-10C.

At operation 1102, the at least one processor 202 may be configured to receive at least one input query from the user via the user device 106. The at least one input query may correspond to a textual input related to technical support. The at least one input query may correspond to technical support regarding troubleshooting inquiries, conceptual understanding, product information requests, comparison queries, problem-solving assistance, operation, and working of a product. The user may be an end user or a customer for accessing technical support and information related to the item.

In some embodiments, the user may enter the technical support query, via the user device 106. In one example, the at least one input query may correspond to “what is table view?”. Further, the at least one input query may correspond to “what are some alternatives?”. In another example, the at least one input query may correspond to “How do I fix error code XYZ on my device?”. In yet another example, the at least one input query may correspond to “Can you provide specifications for product ABC?”. In yet another example, the at least one input query may correspond to “What are the differences between model X and model Y?”. In yet another example, the at least one input query may correspond to “What are the minimum system requirements for software application Z?”. In yet another example, the at least one input query may correspond to “How do I set up wireless networking on my router?”. In yet another example, the at least one input query may correspond to “My computer won't boot up, what should I do?”. In yet another example, the at least one input query may correspond to “what are the steps to install a product?”.

At operation 1104, the at least one processor 202 may be configured to generate an optimized search query based at least on the received at least one input query, the one or more instructions, and the historical data, using the AI model 208. In one example, the optimized search query may correspond to “what are some alternative products for table view?” corresponding to the at least one input query “what are some alternatives?”.

In some embodiments, the generation of the optimized search query may correspond to the generation of relevant and accurate queries. The at least one processor 202 may combine the at least one input query, the chat history, and the one or more instructions, and send the combined at least one input query, chat history, and the one or more instructions to the AI model 208. The AI model 208 may gain an understanding of the user's context, preferences, and past interactions. The at least one input query may correspond to an initial prompt. The at least one input query may further indicate specific assistance sought by the user. The chat history may provide insights into the user's previous interactions and preferences. The chat history may allow the AI model 208 to tailor the at least one input query based at least on past conversations. Further, the one or more instructions may guide the AI model 208 in interpreting and processing the at least one input query effectively. Further, the AI model 208 may generate the at least one optimized search query.

At operation 1106, the at least one processor 202 may be configured to create the at least one vector representation search query based at least on the optimized search query generated, using the AI model 208. The AI model 208 may correspond to the language embedding model 212. The language embedding model 212 may be configured to create the at least one vector representation search query based at least on the generated optimized search query. The at least one vector may correspond to a numeric string. In some embodiments, a text may be converted into the at least one vector. In some embodiments, the text may be converted into a numeric format. The at least one vector may correspond to an array having size 1500, and may expand having size up to 3000. In some embodiments, each of the optimized search query may be converted into a unique at least one vector.

At operation 1108, the at least one processor 202 may determine a plurality of similar vectors corresponding to the at least one vector representation search query from the plurality of vectors stored in the vector database 314. The vector database 314 may comprise vector representation of the plurality of documents. In some embodiments, the at least one processor 202 may search the vector database 314 to determine the plurality of similar vectors for the generated optimized search query. The number of the plurality of similar vectors may not be fixed. In one example, the plurality of similar vectors may correspond to 20 similar vectors corresponding to the at least one vector representation search query for the generated optimized search query. The vector database 314 may store the vector representation of the plurality of documents. The plurality of documents may comprise at least one of the article, a technical publication, a research paper, a white paper, a patent, and a blog.

At operation 1110, the at least one processor 202 may be configured to filter the one or more vectors from the plurality of similar vectors determined, based at least on the predefined tunable threshold, using the AI model 208. In some embodiments, the plurality of similar vectors may comprise the relevant one or more vectors corresponding to the optimized search query. In some embodiments, there may be a possibility that some of the plurality of similar vectors may not precisely match the user's intent or may contain irrelevant information. Further, the AI model 208 may evaluate textual content of each of the plurality of similar vectors in comparison to the generated optimized search query. Further, the AI model 208 may identify the one or more vectors that closely align with the user's at least one search query. Further, less relevant vectors or unrelated vectors may be filtered out. The filtering process may be conducted based at least on the predefined tunable threshold. The predefined tunable threshold may correspond to a maximum number of the one or more vectors filtered from the plurality of similar vectors.

At operation 1112, the at least one processor 202 may be configured to generate the at least one synthesized AI response for the user based at least on the one or more vectors filtered using the AI model 208. The at least one synthesized AI response may comprise at least one of a textual response, pictorial response, video response, audio response, and multimodal response. The filtered one or more vectors from the plurality of similar vectors determined may represent the most relevant plurality of documents from the vector database 314, containing valuable information that may address the at least one input query of the user.

At operation 1114, the at least one processor 202 may display the at least one synthesized AI response generated and one or more feedback parameters to the user. The one or more feedback parameters may be configured to receive feedback from the user on the at least one synthesized AI response. The generated at least one synthesized AI response may comprise at least one of the textual response, pictorial response, video response, audio response, and multimodal response. The one or more feedback parameters may comprise at least one of the thumbs up/thumbs down option 604, the citation verification option 606, the session rating option 608, and the comment option 610. The displayed at least one synthesized AI response may correspond to a solution or an assistance corresponding to the at least one input query entered by the user, via the user device 106.

In some embodiments, the present disclosure may be a web-based platform to provide a user with a chat interface to interact with artificial intelligence (AI). The present disclosure may be a web application. In an embodiment, the present disclosure may be a progressive web app (PWA). The PWA may be an app that's built using web platform technologies, but that provides a user experience like that of a platform-specific app. The PWA may be installed on a device. The PWA may operate while offline and in the background. The PWA may integrate with the device. The PWA may further integrate with other applications installed on the device. In an embodiment, the present disclosure may provide a good user experience even when the device has intermittent network connectivity. Further, the present disclosure may perform operations in the background, even when the main app is not running

In some embodiments, a non-transitory machine-readable information storage medium is disclosed. The non-transitory machine-readable information storage medium may comprise one or more instructions which when executed by at least one processor 202 for receiving at least one input query. The at least one input query may correspond to a textual input related to technical support. Further, the non-transitory machine-readable information storage medium may comprise one or more instructions which when executed by the at least one processor 202 for generating an optimized search query based at least on the received at least one input query, one or more instructions, and historical data, using an artificial intelligence (AI) model 208.

Further, the non-transitory machine-readable information storage medium may comprise one or more instructions which when executed by the at least one processor 202 for creating at least one vector representation search query based at least on the optimized search query generated, using the AI model 208. The at least one vector representation search query corresponds to a vector representation of the at least one optimized search query. Further, the non-transitory machine-readable information storage medium may comprise one or more instructions which when executed by the at least one processor 202 for determining a plurality of similar vectors corresponding to the at least one vector representation search query from a plurality of vectors stored in a vector database 314. Further, the non-transitory machine-readable information storage medium may comprise one or more instructions which when executed by the at least one processor 202 for filtering one or more vectors from the plurality of similar vectors determined, based at least on a predefined tunable threshold, using the AI model 208. Further, the non-transitory machine-readable information storage medium may comprise one or more instructions which when executed by the at least one processor 202 for generating at least one synthesized AI response for the user based at least on the one or more vectors filtered using the AI model 208. Thereafter, the non-transitory machine-readable information storage medium may comprise one or more instructions which when executed by the at least one processor 202 for displaying the at least one synthesized AI response generated and one or more feedback parameters to the user.

The present disclosure discloses several advantages in providing the user with a comprehensive and efficient solution for accessing technology-related information. In some embodiments, by leveraging the AI technology, the system 100 may enable the user to navigate vast repositories of the plurality of documents from specified strategic business groups, global business entities, and product families. The plurality of documents may correspond to knowledge articles and technical publications from specified strategic business groups, global business entities, and product families. The present disclosure empowers the user to ask any question or query related to the technology and receive accurate and relevant information promptly. In some embodiments, when the user may be troubleshooting technical issues, seeking to understand complex concepts, or researching specific products, the system 100 may deliver helpful descriptions. Further, the system 100 discloses a user-friendly interface that may facilitate a quick and efficient access to information. Further, the system 100 may serve as a valuable resource for technical professionals, enthusiasts, and anyone seeking reliable and up-to-date information for solving the queries of the customers.

The present disclosure further introduces a hypothetical answer generation step which may strengthen the alignment between the at least one input query and the retrieved plurality of documents, leading to more precise and relevant responses. Further, the present disclosure trains a text generation model 214. In some embodiments, training the text generation model 214 using verified AI responses may enable iterative refinement of prompts and foster the generation of increasingly accurate hypothetical answer. Further, the present disclosure enhances the system's ability to provide tailored and insightful responses to the at least one input query of the user. Thereafter, the present disclosure improves user satisfaction and the overall usability of the AI-driven search interface.

Many modifications and other embodiments of the disclosure set forth herein will come to mind to one skilled in the art to which these disclosure pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, via at least one processor, at least one input query from a user, wherein the at least one input query corresponds to a textual input related to a technical support;
generating, via the at least one processor, an optimized search query based at least on the received at least one input query, one or more instructions, and historical data, using an artificial intelligence (AI) model;
creating, via the at least one processor, at least one vector representation search query based at least on the optimized search query generated, using the AI model, wherein the at least one vector representation search query corresponds to a vector representation of the at least one optimized search query;
determining, via the at least one processor, a plurality of similar vectors corresponding to the at least one vector representation search query from a plurality of vectors stored in a vector database, wherein the vector database comprises vector representation of a plurality of documents;
filtering, via the at least one processor, one or more vectors from the plurality of similar vectors determined, based at least on a predefined tunable threshold, using the AI model;
generating, via the at least one processor, at least one synthesized AI response for the user based at least on the one or more vectors filtered using the AI model; and
displaying, via the at least one processor, the at least one synthesized AI response generated and one or more feedback parameters to the user, wherein the one or more feedback parameters are configured to receive feedback from the user on the at least one synthesized AI response.

2. The method of claim 1, wherein the one or more instructions correspond to instructions for retrieving intent from the at least one input query received from the user and the historical data corresponds to chat history of the user.

3. The method of claim 2, wherein the optimized search query corresponds to a query generated after filtering out common words and sentences from the at least one input query, for retrieving the intent from the at least one input query.

4. The method of claim 1, wherein the predefined tunable threshold corresponds to a maximum number of the one or more vectors filtered from the plurality of similar vectors.

5. The method of claim 1, wherein the at least one synthesized AI response comprises at least one of a textual response, pictorial response, video response, audio response, or multimodal response.

6. The method of claim 1, wherein the one or more feedback parameters comprises at least one of thumbs up/thumbs down option, a citation verification option, a session rating option, and a comment option.

7. The method of claim 1, further comprising:
receiving, via the at least one processor, the feedback corresponding to the at least one synthesized AI response from the user based at least on the one or more feedback parameters displayed to the user;
collating, via the at least one processor, the feedback received from the user on each of the at least one synthesized AI response to create a feedback database; and
matching, via the at least one processor, the optimized search query with the feedback database, wherein upon successful matching, the at least one processor is configured to provide verified citations to the user.

8. The method of claim 7 further comprising training, via the at least one processor, the AI model based at least on the feedback received from the user and the at least one optimized search query.

9. The method of claim 8 further comprising generating, via the at least one processor, a hypothetical answer in response to the at least one input query based at least on the trained AI model.

10. The method of claim 9, wherein the AI model comprises a language understanding model, a language embedding model, and a text generation model, wherein the language understanding model is configured to generate the optimized search query, filter the one or more vectors, and generate the at least one synthesized AI response, the language embedding model is configured to create the at least one vector representation search query based at least on the generated optimized search query, and the text generation model is configured to generate the hypothetical answer in response to the at least one input query.

11. The method of claim 1, wherein the plurality of documents comprises at least one of an article, a technical publication, a research paper, a white paper, a patent, or a blog.

12. A system comprising:
a memory; and
at least one processor communicatively coupled to the memory, wherein the at least one processor is configured to:
receive at least one input query from a user, wherein the at least one input query corresponds to a textual input related to a technical support;
generate an optimized search query based at least on the received at least one input query, one or more instructions, and historical data, using an artificial intelligence (AI) model;
create at least one vector representation search query based at least on the optimized search query generated, using the AI model, wherein the at least one vector representation search query corresponds to a vector representation of the at least one optimized search query;
determine a plurality of similar vectors corresponding to the at least one vector representation search query from a plurality of vectors stored in a vector database, wherein the vector database comprises vector representation of a plurality of documents;
filter one or more vectors from the plurality of similar vectors determined, based at least on a predefined tunable threshold, using the AI model;
generate at least one synthesized AI response for the user based at least on the one or more vectors filtered using the AI model; and
display the at least one synthesized AI response generated and one or more feedback parameters to the user, wherein the one or more feedback parameters are configured to receive feedback from the user on the at least one synthesized AI response.

13. The system of claim 12, wherein the one or more instructions correspond to instructions for retrieving intent from the at least one input query received from the user and the historical data corresponds to chat history of the user, and wherein the optimized search query corresponds to a query generated after filtering out common words and sentences from the at least one input query, for retrieving the intent from the at least one input query.

14. The system of claim 12, wherein the predefined tunable threshold corresponds to a maximum number of the one or more vectors filtered from the plurality of similar vectors.

15. The system of claim 12, wherein the at least one synthesized AI response comprises at least one of a textual response, pictorial response, video response, audio response, or multimodal response.

16. The system of claim 12, wherein the one or more feedback parameters comprises at least one of thumbs up/thumbs down option, a citation verification option, a session rating option, and a comment option.

17. The system of claim 12, wherein the at least one processor is further configured to:
receive the feedback corresponding to the at least one synthesized AI response from the user based at least on the one or more feedback parameters displayed to the user;
collate the feedback received from the user for each of the at least one synthesized AI response to create a feedback database;
match the optimized search query with the feedback database, wherein upon successful matching, the at least one processor is configured to provide verified citations to the user;
train the AI model based at least on the feedback received from the user and the at least one optimized search query; and
generate a hypothetical answer in response to the at least one input query based at least on the trained AI model.

18. The system of claim 17, wherein the AI model comprises a language understanding model, a language embedding model, and a text generation model, wherein the language understanding model is configured to generate the optimized search query, filter the one or more vectors, and generate the at least one synthesized AI response, the language embedding model is configured to create the at least one vector representation search query based at least on the generated optimized search query, and the text generation model is configured to generate the hypothetical answer in response to the at least one input query.

19. The system of claim 12, wherein the plurality of documents comprises at least one of an article, a technical publication, a research paper, a white paper, a patent, and a blog.

20. A non-transitory machine-readable information storage medium comprising one or more instructions which when executed by at least one processor causes the at least one processor to:
receive at least one input query from a user, wherein the at least one input query corresponds to a textual input related to a technical support;
generate an optimized search query based at least on the received at least one input query, one or more instructions, and historical data, using an artificial intelligence (AI) model;
create at least one vector representation search query based at least on the optimized search query generated, using the AI model, wherein the at least one vector representation search query corresponds to a vector representation of the at least one optimized search query;
determine a plurality of similar vectors corresponding to the at least one vector representation search query from a plurality of vectors stored in a vector database, wherein the vector database comprises vector representation of a plurality of documents;
filter one or more vectors from the plurality of similar vectors determined, based at least on a predefined tunable threshold, using the AI model;
generate at least one synthesized AI response for the user based at least on the one or more vectors filtered using the AI model; and
display the at least one synthesized AI response generated and one or more feedback parameters to the user, wherein the one or more feedback parameters are configured to receive feedback from the user on the at least one synthesized AI response.
